(19) United States
(12) Patent Application Publication
(10) Pub. No.: US 2026/0361458 A1
(43) Pub. Date: Nov. 12, 2026

(54) PARTIAL CODE BLOCK SHAPING FOR MULTI-LAYER TRANSMISSIONS

(71) Applicant: QUALCOMM Incorporated, San Diego, CA (US)

(72) Inventors: Kirill IVANOV, La Jolla, CA (US); Wei YANG, San Diego, CA (US); Jing JIANG, San Diego, CA (US)

(21) Appl. No.: 19/205,007

(22) Filed: May 12, 2025

(51) Int. Cl. H04L 1/00; H04L 27/34

(52) U.S. Cl. CPC H04L 1/0057; H04L 1/0061; H04L 27/34

(57) ABSTRACT

This disclosure provides methods, components, devices and systems for partial code block shaping for multi-layer transmissions. A wireless device (such as a user equipment (UE) or a network node) may communicate one or more messages that indicate a first quantity of transmission layers of a multi-layer transmission that are to be shaped using a partial code block shaping scheme. The wireless device may use a first set of parameters to perform partial code block shaping on a first set of bits to generate a set of code block shaped bits. In some aspects, the wireless device may derive the first set of parameters for the partial code block shaping scheme from a second set of parameters for a full code block shaping scheme. The wireless device may transmit the set of code block shaped bits and a set of unshaped code block bits on respective layers of the multi-layer transmission.

### TECHNICAL FIELD

The present disclosure relates to wireless communication, and more specifically to systems, devices, methods, and techniques associated with partial code block shaping for multi-layer transmissions.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network nodes (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by an apparatus is described. The method may include communicating one or more messages indicative of a first quantity of transmission layers of a multi-layer transmission that are to be shaped in accordance with a partial code block shaping scheme, performing partial code block shaping on a first set of multiple bits to generate a set of multiple code block shaped bits in accordance with a first set of parameters for the partial code block shaping scheme, the first set of parameters for the partial code block shaping scheme being derived from a second set of parameters for a full code block shaping scheme, transmitting the set of multiple code block shaped bits of the multi-layer transmission on the first quantity of layers, and transmitting a set of multiple unshaped code block bits of the multi-layer transmission on a second quantity of layers.

An apparatus for wireless communications is described. The apparatus may include a processing system that includes processor circuitry and memory circuitry that stores code. The processing system may be configured to cause the apparatus to communicate one or more messages indicative of a first quantity of transmission layers of a multi-layer transmission that are to be shaped in accordance with a partial code block shaping scheme, perform partial code block shaping on a first set of multiple bits to generate a set of multiple code block shaped bits in accordance with a first set of parameters for the partial code block shaping scheme, the first set of parameters for the partial code block shaping scheme being derived from a second set of parameters for a full code block shaping scheme, transmit the set of multiple code block shaped bits of the multi-layer transmission on the first quantity of layers, and transmit a set of multiple unshaped code block bits of the multi-layer transmission on a second quantity of layers.

Another apparatus for wireless communications is described. The apparatus may include means for communicating one or more messages indicative of a first quantity of transmission layers of a multi-layer transmission that are to be shaped in accordance with a partial code block shaping scheme, means for performing partial code block shaping on a first set of multiple bits to generate a set of multiple code block shaped bits in accordance with a first set of parameters for the partial code block shaping scheme, the first set of parameters for the partial code block shaping scheme being derived from a second set of parameters for a full code block shaping scheme, means for transmitting the set of multiple code block shaped bits of the multi-layer transmission on the first quantity of layers, and means for transmitting a set of multiple unshaped code block bits of the multi-layer transmission on a second quantity of layers.

A non-transitory computer-readable medium storing code for wireless communications is described. The code may include instructions executable by one or more processors to communicate one or more messages indicative of a first quantity of transmission layers of a multi-layer transmission that are to be shaped in accordance with a partial code block shaping scheme, perform partial code block shaping on a first set of multiple bits to generate a set of multiple code block shaped bits in accordance with a first set of parameters for the partial code block shaping scheme, the first set of parameters for the partial code block shaping scheme being derived from a second set of parameters for a full code block shaping scheme, transmit the set of multiple code block shaped bits of the multi-layer transmission on the first quantity of layers, and transmit a set of multiple unshaped code block bits of the multi-layer transmission on a second quantity of layers.

In some examples of the method, apparatus, and non-transitory computer-readable medium described herein, performing the partial code block shaping scheme on the first set of multiple bits may include operations, features, means, or instructions for deriving the first set of parameters for the partial code block shaping scheme from the second set of parameters for the full code block shaping scheme, the first set of parameters including a first coding rate for the partial code block shaping scheme and the full code block shaping scheme, a first shaping parameter for the partial code block shaping scheme that may be increased relative to a second shaping parameter for the full code block shaping scheme, and a first quantity of the first set of multiple bits for the partial code block shaping scheme and the full code block shaping scheme.

In some examples of the method, apparatus, and non-transitory computer-readable medium described herein, performing the partial code block shaping scheme on the first set of multiple bits may include operations, features, means, or instructions for deriving the first set of parameters for the partial code block shaping scheme from the second set of parameters for the full code block shaping scheme, the first set of parameters including a first coding rate for the partial code block shaping scheme that may be decreased relative to a second coding rate for the full code block shaping scheme, a first shaping parameter for the partial code block shaping scheme and the full code block shaping scheme, and a first quantity of the first set of multiple bits for the partial code block shaping scheme and the full code block shaping scheme.

In some examples of the method, apparatus, and non-transitory computer-readable medium described herein, the first set of parameters for the partial code block shaping scheme and the second set of parameters for the full code block shaping scheme include a same set of parameters, the first set of parameters including a first coding rate applicable to the full code block shaping scheme, a first shaping parameter applicable to the full code block shaping scheme, and a first quantity of the first set of multiple bits applicable to the full code block shaping scheme.

Some examples of the method, apparatus, and non-transitory computer-readable medium described herein may further include operations, features, means, or instructions for communicating a capability report indicative of a shaping capability, the shaping capability including a maximum supported quantity of shaped layers for a bandwidth for transmission of the multi-layer transmission.

In some examples of the method, apparatus, and non-transitory computer-readable medium described herein, the maximum supported quantity of shaped layers for a first supported bandwidth may be different from the maximum supported quantity of shaped layers for a second supported bandwidth.

In some examples of the method, apparatus, and non-transitory computer-readable medium described herein, performing the partial code block shaping scheme on the first set of multiple bits may include operations, features, means, or instructions for generating the set of multiple code block shaped bits, a set of multiple unshaped data bits, and a set of multiple parity bits in accordance with the partial code block shaping scheme and modulating, using a modulation scheme, the set of multiple code block shaped bits, the set of multiple unshaped data bits, and the set of multiple parity bits, where the set of multiple code block shaped bits may be transmitted on one or more first layers of the multi-layer transmission, the set of multiple unshaped data bits and the set of multiple parity bits being transmitted on one or more second layers of the multi-layer transmission.

In some examples of the method, apparatus, and non-transitory computer-readable medium described herein, the first quantity of transmission layers may be indicated using a set of values included in a field of the one or more messages, the set of values including at least a first value indicative of no code block shaping, a second value indicative of the full code block shaping scheme, and one or more values between the first value and the second value indicative of the partial code block shaping scheme.

In some examples of the method, apparatus, and non-transitory computer-readable medium described herein, the first set of parameters and the second set of parameters include at least a shaping parameter and a coding rate, the shaping parameter being a Maxwell-Boltzmann parameter, and the coding rate being a forward error correction (FEC) rate.

### BRIEF DESCRIPTION OF THE DRAWINGS

FIG. 1 shows an example of a wireless communication system.

FIG. 2 shows an example of a signaling configuration that supports partial code block shaping for multi-layer transmissions.

FIG. 3 shows an example of a block diagram that supports partial code block shaping for multi-layer transmissions.

FIG. 4 shows examples of code block shaping schemes that support partial code block shaping for multi-layer transmissions.

FIG. 5 shows an example of a process flow that supports partial code block shaping for multi-layer transmissions.

FIG. 6 shows a block diagram of a processing system that supports partial code block shaping for multi-layer transmissions.

FIG. 7 shows a diagram of a system including a UE that supports partial code block shaping for multi-layer transmissions in accordance with one or more aspects of the present disclosure.

FIG. 8 shows a diagram of a system including a network node that supports partial code block shaping for multi-layer transmissions in accordance with one or more aspects of the present disclosure.

FIG. 9 shows a flowchart illustrating methods that support partial code block shaping for multi-layer transmissions.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, a wireless device (such as a user equipment (UE) or a network node) may utilize a code block shaping scheme (e.g., a probabilistic shaping scheme, a constellation shaping scheme) to encode code blocks of a multi-layer transmission, such as for multiple input multiple output (MIMO) type communications. Code block shaping may allow the wireless device to manipulate information bits such that symbols associated with a high transmission power are transmitted relatively less frequently than symbols associated with a low transmission power, based on a probability distribution used for the shaping. Some shaping techniques (such as probabilistic constellation shaping (PCS)), may be used to improve the efficiency of higher-order modulations by shaping the transmitted symbols to have a target shaped probability distribution, such as a Maxwell-Boltzmann distribution. In some shaping techniques, information bits are fed into a shaper, which generates shaped information bits as well as some residual unshaped information bits. The output of the shaper may be sent to a systematic forward error correction (FEC) encoder, which produces parity bits. The shaped information bits may then be mapped to respective amplitudes of modulated symbols, and the unshaped information bits and parity bits may be mapped to the sign of the modulated symbols. In some cases, however, encoding gain and increased system performance may be realized for multi-layer transmissions if some layers are shaped, and at least some other layers are left unshaped. For example, the transmitting device may perform partial code block shaping by shaping a subset of the layers of the multi-layer transmission, and leaving the rest of the layers unshaped.

To enable code block shaping, the transmitting device may be configured with a set of parameters that correspond to the code block shaping. For example, the transmitting device may be configured with a shaping parameter (such as a Maxwell-Boltzmann shaping parameter) which is associated with a target probability distribution for the shaping, a FEC rate parameter which indicates a coding rate for the code block shaping, and a quantity of data bits that are to be shaped. To support partial shaping for multi-layer transmissions, the transmitting device may derive transmission parameters for the partial shaping using parameters associated with a full code block shaping scheme. For example, the transmitting device may identify the shaping parameter (e.g., the Maxwell-Boltzmann parameter), a coding parameter (e.g., an FEC parameter), and the quantity of bits to be shaped in the partial shaping based on corresponding parameters used in a full-shaping scheme. In some examples, the transmitting device may use the same shaping parameter while decreasing the coding parameter. In some examples, the transmitting device may use the same coding parameter while increasing the shaping parameter. In some examples, the shaping and coding parameters may stay the same for the full shaping and the partial shaping. The transmitting device may apply the partial shaping to shape at least some of the layers of the multi-layer transmission, while leaving the remaining layers unshaped.

In some examples, a wireless communication system may support signaling which enables the partial code block shaping scheme. For example, a network node may transmit a message that includes one or more fields, including a field that indicates how many layers are to be shaped. Additionally, or alternatively, the transmitting device (such as a UE) may transmit capability signaling to notify the receiving device (such as the network node) of a set of partial-shaping capabilities of the receiving device. For example, the UE may transmit a UE capability report which indicates a maximum quantity of shaped layers for one or more supported bandwidths, various supported shaping parameters, among other capability information to indicate support for partial code block shaping.

Particular aspects of the subject matter described in this disclosure can be implemented to realize one or more of the following potential advantages. In some examples, by supporting derivation of parameters for partial code block shaping from corresponding parameters for full code block shaping, the described techniques can be used to reduce processing and storage burden for a transmitting device, as the transmitting device may shape a subset of bits (rather than the total quantity of bits), and may use a single set of parameters for a full code block shaping to determine appropriate parameters for partial code block shaping. Additionally, or alternatively, the techniques described herein may further decrease on-device storage and/or memory burden by allowing the transmitting device to store a single modulation and coding scheme (MCS) table for both full code block shaping and partial code block shaping (rather than storing multiple MCS tables for different combinations of parameters for the partial code block shaping). Additionally, or alternatively, the techniques described herein may allow for increased device performance and signaling performance, including increased signal to interference plus noise (SINR) ratio based on the support for code block shaping (both full code block shaping and partial code block shaping).

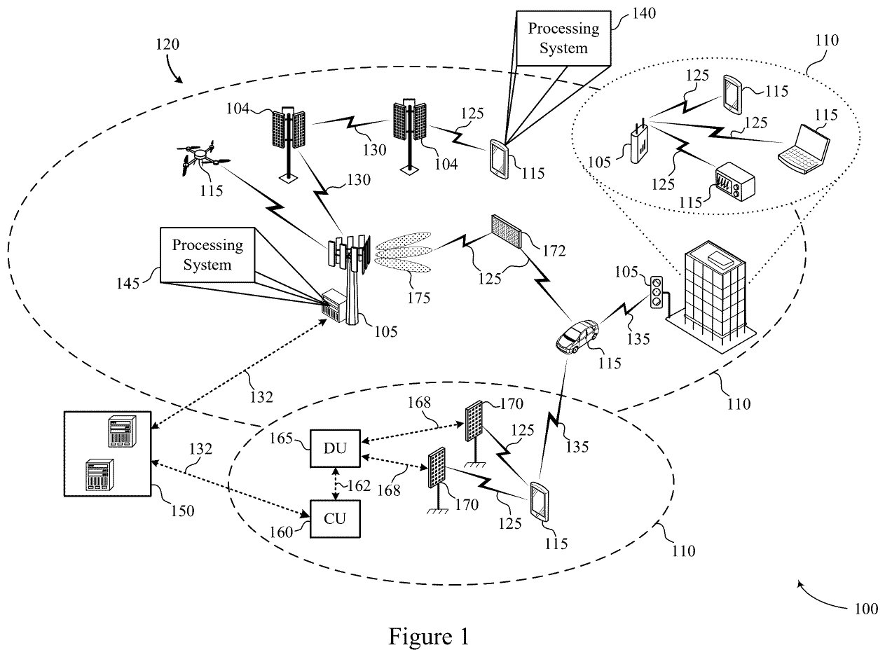

FIG. 1 shows an example of a wireless communication system 100. The wireless communication system 100 includes a core network 150 and a RAN 120 that support communication with one or more devices, such as UEs 115. A RAN 120 may include one or more network nodes 105 (which may be additionally, or alternatively, referred to as network entities) configured to support wireless communication with the UEs 115.

The wireless communication system 100 may support communication among network nodes 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network node 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network nodes 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network node 105 may support wireless communication in accordance with one or more coverage areas 110, and may be referred to as a network element, a network node, a RAN node, or network equipment, among other nomenclature. One or more of the network nodes 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network nodes 105 support communication for one or more coverage areas 110 using the same or different RATs.

In some examples, a network node 105 may be implemented in an aggregated (such as monolithic, standalone) architecture, which may utilize a protocol stack that is physically or logically integrated within one network node 105 (such as a single physical RAN node). In some other examples, a network node 105 may be implemented in a disaggregated architecture, which may utilize a protocol stack that is physically or logically distributed among multiple network nodes 105, including in an integrated access and backhaul (IAB) network, an open RAN (O-RAN), or a virtualized RAN (vRAN). In a disaggregated architecture, a network node 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network nodes 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network node 105 and a UE 115 may be supported using one or more of a communication link 125 (such as a Uu interface), which may include downlink communication from a network node 105 to a UE 115, uplink communication from a UE 115 to a network node 105, or both. Direct wireless communication between UEs 115 may be supported using a communication link 135 (such as a device-to-device (D2D) communication link, a sidelink, a PC5 interface).

Communication between a network node 105 and a core network 150 may be supported using a backhaul link 132 (such as an S1, N2, N3, NG, or other interface). In some implementations, communication between network nodes 105 may be supported using a backhaul link 132 (such as an X2, Xn, or other interface) either directly (such as directly between network nodes 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network nodes 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network node 105 or a UE 115.

Beamforming, such as directional transmission or directional reception, is a signal processing technique that may be used at a transmitting device or a receiving device (such as at a network node 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication. Devices in wireless communication system 100 may communicate over unlicensed spectrum, such as the 5 GHz band, the 2.4 GHz band, the 60 GHz band, the 3.6 GHz band, and/or the 900 MHz band. The unlicensed spectrum may also include other frequency bands.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network node 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network node 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Devices in the wireless communication system 100 (such as network nodes 105, UEs 115) may modulate and code information prior to transmission of a signal (such as of a physical channel). A modulation and coding scheme (MCS) may define how modulation and coding is to be performed, which may include an implementation in accordance with a modulation order and a target code rate. A code rate may be achieved using a channel coding scheme such as forward error correction (FEC) (such as to add redundancy). Examples of FEC include block codes, convolutional codes, and linear error-correcting codes. At a receiver (such as to demodulate modulation symbols of a physical channel), a decoder may employ probabilistic or iterative techniques to perform soft decision-making, and code blocks for bit streams may employ a check code (such as a cyclic redundancy check (CRC) code, a low-density parity-check (LDPC)) to detect and correct decoding errors.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network node 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network node 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network nodes 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network nodes 105 and UEs 115 may receive and measure transmitted reference signals to support one or more of these and other functions.

Devices of the wireless communication system 100 may be configured to support one or more aspects of the described techniques for partial code block shaping for multi-layer transmissions. For example, a UE 115 may include a processing system 140, and a network node 105 may include a processing system 145, each of which may be configured to cause the respective device to perform (such as being configured as means for performing) one or more of the described operations. By configuring a processing system 140, a processing system 145, or a combination thereof in accordance with the described techniques, the wireless communication system 100 (such as the RAN 120) may support increased system performance based on use of partial code block shaping. For example, in some wireless communication systems, a wireless device (such as a UE 115 or a network node 105) may utilize a code block shaping scheme to encode code blocks of a multi-layer transmission. In some shaping techniques, information bits are fed into a shaper, which generates shaped information bits as well as some residual unshaped information bits. The output of the shaper may be sent to a systematic FEC encoder, which produces parity bits. The shaped information bits may then be mapped to respective amplitudes of modulated symbols, and the unshaped information bits and parity bits may be mapped to the sign of the modulated symbols. In some cases, however, encoding gain and increased system performance may be realized for multi-layer transmissions if some layers are shaped, and at least some other layers are left unshaped.

To enable code block shaping, the transmitting device may be configured with a set of parameters that correspond to the code block shaping. For example, the transmitting device may be configured with a shaping parameter which is associated with a target probability distribution for the shaping, a FEC rate parameter which indicates a coding rate for the code block shaping, and a quantity of data bits that are to be shaped. To support partial shaping for multi-layer transmissions, the transmitting device may derive transmission parameters for the partial shaping using parameters associated with a full code block shaping scheme. For example, the transmitting device may identify the shaping parameter, a coding parameter (e.g., an FEC parameter), and the quantity of bits to be shaped in the partial shaping based on corresponding parameters used in a full-shaping scheme.

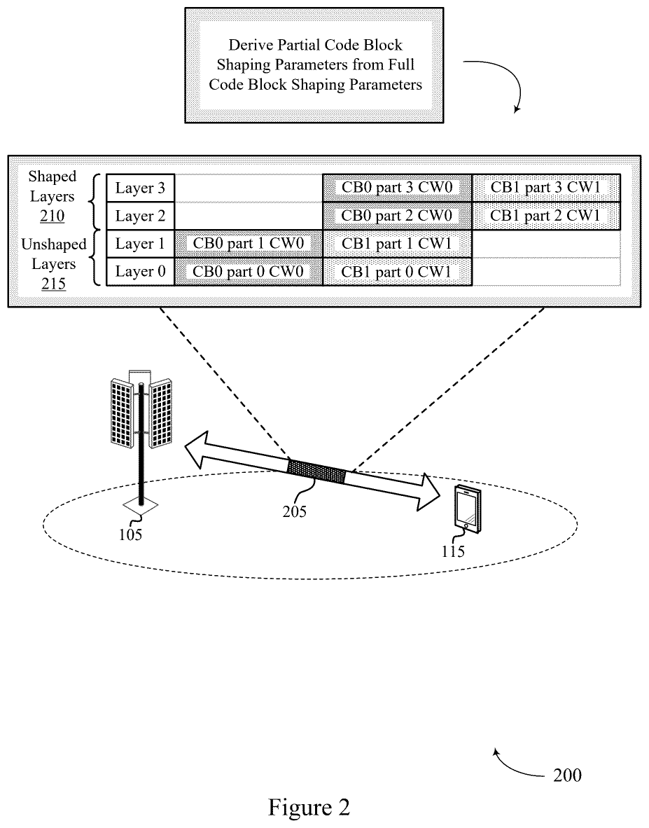

FIG. 2 shows an example of a signaling configuration 200 that supports partial code block shaping for multi-layer transmissions. For example, the signaling configuration 200 supports communication between wireless devices in a wireless system, such as between a UE 115 and a network node 105, each of which may be examples of UEs 115 and network nodes 105 described with reference to FIG. 1. In some aspects, the UE 115 and the network node 105 may be capable of supporting (e.g., performing, receiving, processing) code block shaping schemes, such as full code block shaping and partial code block shaping.

The UE 115 and the network node 105 may support different MIMO systems, such as dual codeword MIMO and single codeword MIMO. For example, in dual codeword MIMO techniques, a wireless device may transmit a single transmission using two separate codewords (e.g., two independent streams of data), which may enhance data transmission efficiency and reliability. Dual codeword MIMO may support transmission of multiple data streams simultaneously using multiple antennas. In some cases, dual codeword MIMO may include encoding and transmitting different codewords (which include a set of code blocks) at different transmission layers. For example, a first codeword (e.g., CW0) may include a first set of code blocks (e.g., code block 0 CW0, code block 1 CW0, code block 2 CW0) and may be encoded and transmitted at a first transmission layer (e.g., Layer 0), and a second codeword (e.g., CW1) may include a second set of code blocks (e.g., code block 0 CW1, code block 1 CW1, code block 2 CW1) and may be encoded and transmitted at a second transmission layer (e.g., Layer 1). In some examples, the first codeword and the second codeword may be assigned different coding rates at the transmitting device, and the receiving device may perform successive interference cancellation (SIC) for both layers when accurate per-codeword channel quality information (CQI) is known by the receiver. For example, the receiving device (such as the UE 115) may use SIC to decode signals sequentially by canceling the detected signal (e.g., from the first layer or the second layer) from the aggregate received signal (e.g., the multi-layer transmission 205), and then decoding the next strongest signal.

For single codeword MIMO techniques, a transmitting device (such as the UE 115 or the network node 105) may use a single codeword for data transmission, where the data is processed and modulated as a single stream (e.g., rather than being split into multiple streams or codewords as in dual codeword MIMO). In single codeword MIMO, modulated symbols may be distributed across one or more layers (e.g., Layer 0, Layer 1) for transmission, and a receiving device may perform iterative demodulation and/or decoding across the one or more layers (e.g., using irregular low density parity check coding (LDPC) for the iterative demodulation and/or decoding). The single codeword (e.g., CW0) may include a set of code blocks that are split across multiple layers of the transmission. For example, a first code block (e.g., code block 0) a second code block (e.g., code block 1), and a third code block (e.g., code block 2) may be split across two transmission layers (e.g., Layer 0 and Layer 1). In some aspects, single codeword MIMO may be efficient and have reduced complexity relative to dual-codeword MIMO, especially with transmission of relatively few transmission layers (e.g., fewer than 4 layers).

In some cases, the UE 115 and the network node 105 may support single codeword MIMO with spatial coupling (using a diagonal layered architecture or D-BLAST). For example, the encoding device (e.g., the UE 115 or the network node 105) may use a space time arrangement that corresponds to a diagonal layering. The encoding device may demultiplex an information bit stream into several sub-streams (e.g., serial to parallel), and may code each sub-stream separately and map each sub-stream to complex symbols. The encoding device may then disperse symbols of each sub-stream “diagonally” across antennas and time. The decoding device (such as the UE 115 or the network node 105) may decode each of the layers (and may perform successive interference cancellation of the layers during iterative decoding) in order to receive the signal.

In some examples, the single codeword rate may be selected to match the collective channel quality across multiple layers of the multi-layer transmission 205 using the diagonal layered architecture (e.g., similar to D-BLAST), which may allow a single code word to capture a larger quantity of channel realizations. In some aspects, different parts of code blocks (from a same codeword) may be transmitted on different layers. For example, a first layer may include a second part of a first code block (e.g., code block 0 part 1, CW0) and a second part of a second code block (e.g., code block 1, part 1, CW0), and a second layer may include a first part of the first code block (e.g., code block 0, part 0, CW0), a first part of the second code block (e.g., code block 1, part 0, CW0), and a first part of a third code block (e.g., code block 2, part 0, CW0). In such examples, the receiving device may perform successive interference cancellation in order to decode the multi-layer transmission 205 by first demodulating and decoding the first code block (e.g., code block 0), and may subtract the signal component of the first code block from the received signal, and then may demodulate and decode the second code block (e.g., code block 1). The procedure of successive cancellation of different code blocks may be performed iteratively until all code blocks are successfully decoded from the multi-layer transmission 205 (or until code block decoding failure is declared).

In some implementations, a wireless device (e.g., a user equipment (UE) or a network node) may utilize constellation shaping processes (e.g., probabilistic shaping) for encoding code blocks of a multi-layer transmission 205. Constellation shaping may allow the wireless device to manipulate information bits such that symbols associated with a high transmission power are transmitted less frequently than symbols associated with a low transmission power. Some shaping techniques (such as probabilistic constellation shaping (PCS)), may be used to improve the efficiency of higher-order modulations by shaping the transmitted symbols to have a specific, shaped probability distribution. In some shaping techniques, information bits are fed into a shaper, which generates shaped information bits as well as some residual unshaped information bits. The output of the shaper may be sent to a systematic FEC encoder, which produces parity bits. The shaped information bits may then be mapped to respective amplitudes of modulated symbols, and the unshaped information bits and parity bits may be mapped to the sign of the modulated symbols. In some cases, however, encoding gain and increased system performance may be realized for multi-layer transmission 205 if some layers are shaped, and other layers are left unshaped.

For example, a transmitting device (which may be the network node 105 or the UE 115) may shape all of the layers or a subset of the layers of the multi-layer transmission 205 (e.g., all or some of Layer 0, Layer 1, Layer 2, and Layer 3). In some examples, the transmitting device may perform half code block shaping a by shaping half of the layers (e.g., shaped layers 210) using probabilistic amplitude shaping (PAS) on layers that are de-mapped using reduced-complexity maximum likelihood (rML) techniques, and by leaving the other half of the layers unshaped (e.g., unshaped layer 215) and modulating the unshaped layers using uniform quadrature amplitude modulation (QAM) (such as binary phase shift keying (BPSK), quadrature phase shift keying (QPSK), 16 QAM (16-state QAM), 64 QAM (64-state QAM), among other QAM types) and minimized mean square error (MMSE) techniques. In some aspects, half code block shaping (among other partial code block shaping schemes) may allow for similar performance as full code block shaping schemes for low correlation, and relatively higher performance for medium correlation. In addition, partial code block shaping schemes may be relatively more area efficient for a device (e.g., fewer than all of the layers are shaped, fewer than the maximum quantity of bits are shaped, leading to a relatively smaller shaper and/or de-shaper area). The techniques discussed herein may be implemented to support partial code block PAS as well as full code block PAS.

To enable code block shaping, a transmitting device (such as the UE 115 and/or the network node 105) may be configured with a set of parameters for the code block shaping. For example, the transmitting device may be configured with a shaping parameter (such as a Maxwell-Boltzmann parameter) which is associated with a target probability distribution for the shaping, a FEC rate parameter, and a quantity of data bits that are to be shaped. To support partial shaping for multi-layer transmissions, the transmitting device (such as the UE 115 and/or the network node 105) may derive transmission parameters for the partial shaping using existing parameters used for a full code block shaping scheme. For example, the transmitting device may identify the shaping parameter (e.g., the Maxwell-Boltzmann parameter), a coding parameter (e.g., an FEC parameter), and the quantity of bits to be shaped in the partial shaping based on corresponding parameters used in a full-shaping scheme. In some examples, the transmitting device may use the same shaping parameter while decreasing the coding parameter. In some examples, the transmitting device may use the same coding parameter while increasing the shaping parameter. In some examples, the shaping and coding parameters may stay the same for the full shaping and the partial shaping. The transmitting device may apply the partial shaping to shape at least some of the layers (e.g., shaped layers 210) of the multi-layer transmission 205 and may transmit shaped code block bits via the shaped layers, while leaving the remaining layers unshaped (e.g., unshaped layers 215), and transmitting unshaped code block bits via the unshaped layers.

In some examples, the network node 105 may communicate signaling which enables the partial code block shaping scheme. For example, the network node 105 may transmit a message that includes one or more fields, including a field that indicates how many layers are to be shaped (e.g., a field value of 0 indicates no shaping, a field value equal to the total quantity of transmission layers of the multi-layer transmission 205 indicates full code block shaping, and any field value in between 0 and the total quantity of transmission layers indicates partial code block shaping). In some examples, the signaling may be a DCI message, an RRC message, or a MAC-CE. For example, in cases in which partial code block shaping is signaled via RRC and/or MAC-CE, the RRC and/or the MAC-CE may additionally indicate the quantity of shaped layers for each corresponding rank. In some such examples, the RRC and/or MAC-CE message may include or indicate a table which includes information regarding the corresponding quantity of shaped layers for each rank.

Additionally, or alternatively, the transmitting device (such as the UE 115) may transmit capability signaling to notify the receiving device (such as the network node 105) of a set of partial-shaping capabilities of the receiving device. For example, the UE 115 may transmit a UE capability report which indicates a maximum quantity of shaped layers for one or more supported bandwidths. In some such examples, the maximum quantity of shaped layers per supported bandwidth may be determined by the total shaping capability of the UE 115, such that the UE 115 may support different quantities of shaped layers for different bandwidths (e.g., with the same hardware, the UE 115 may support up to four layer shaping for 100 MHz bandwidth, and up to two layer shaping for 200 MHz bandwidth, although other layer per-bandwidth combinations are possible).

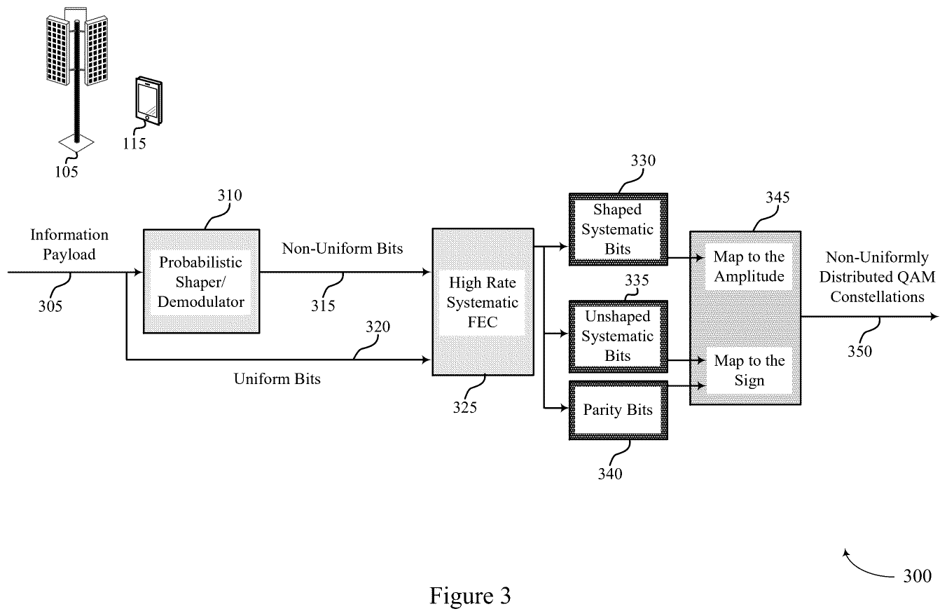

FIG. 3 shows an example of a block diagram 300 that supports partial code block shaping for multi-layer transmissions. In some examples, one or more of the elements, structures, or operations described with reference to FIG. 3 may be performed by a network node (e.g., the network node 105 as described with reference to FIGS. 1 and 2) or a UE (such as a UE 115 as described with reference to FIGS. 1 and 2). One or more of the elements described with reference to FIG. 3 may be implemented in hardware or a combination of hardware and instructions or code (e.g., one or more processors with instructions). For example, a probabilistic shaper and demodulator 310, a high rate systematic encoder 325 (or any other type of encoder), and QAM modulation 345 may be implemented in hardware or a combination of hardware and instructions. In some examples, the network node 105, the UE 115, or both, may include the probabilistic shaper and demodulator 310, the high rate systematic encoder 325, and QAM modulation 345.

Payload bits 305 may be provided to the probabilistic shaper and demodulator 310. The probabilistic shaper and demodulator 310 may split the payload bits into non-uniform bits 315 (e.g., shaped using a non-uniform probability distribution for the occurrence of symbols in a constellation) and uniform bits 320 (e.g., unshaped bits, bits conforming with a uniform probability distribution), both of which may be fed into the high rate systematic encoder 325 (such as a systematic FEC encoder), which may encode the non-uniform bits 315 and the uniform bits 320 using FEC encoding. In cases of partial code block shaping, the high rate systematic encoder 325 may produce a set of shaped systematic bits 330, a set of unshaped systematic bits 335, and a set of parity bits 340. In some examples, the high rate systematic encoder 325 may encode the original data of the non-uniform bits 315 and the uniform bits 320 using an FEC algorithm that adds redundant bits (e.g., error correction bits) to the data so that the receiving device may detect the data with reduced error rates. In some examples, the partial code block shaping may allow for encoding and transmission of shaped code block bits on a first set of layers of a multi-layer transmission, and unshaped code block bits of a second set of layers (different from the first set of layers) of the multi-layer transmission.

The set of shaped systematic bits 330 may be mapped to the amplitude of a QAM constellation during the QAM modulation 345, and both the set of unshaped systematic bits 335 and the set of parity bits 340 may be mapped to the sign of the QAM constellation during the QAM modulation 345. In some examples, the QAM modulation 345 may include a digital modulation which varies both the amplitude and phase of a carrier wave, such as amplitude shift keying (ASK) or phase shift keying (PSK), or variants thereof such as BPSK, QPSK, among other modulation techniques. The QAM modulation 345 may produce non-uniformly distributed QAM constellations 350 for transmission to a receiving device.

One or more of the components described with reference to FIG. 3 may be utilized to perform one or more of the shaping, mapping, encoding, generating, transmitting, or other operations described with reference to FIG. 2. For instance, components described with reference to FIG. 3 may perform partial code block shaping via the generation of non-shaped payload bits, shaped payload bits, and parity bits based on one or more parameters derived from full code block shaping schemes.

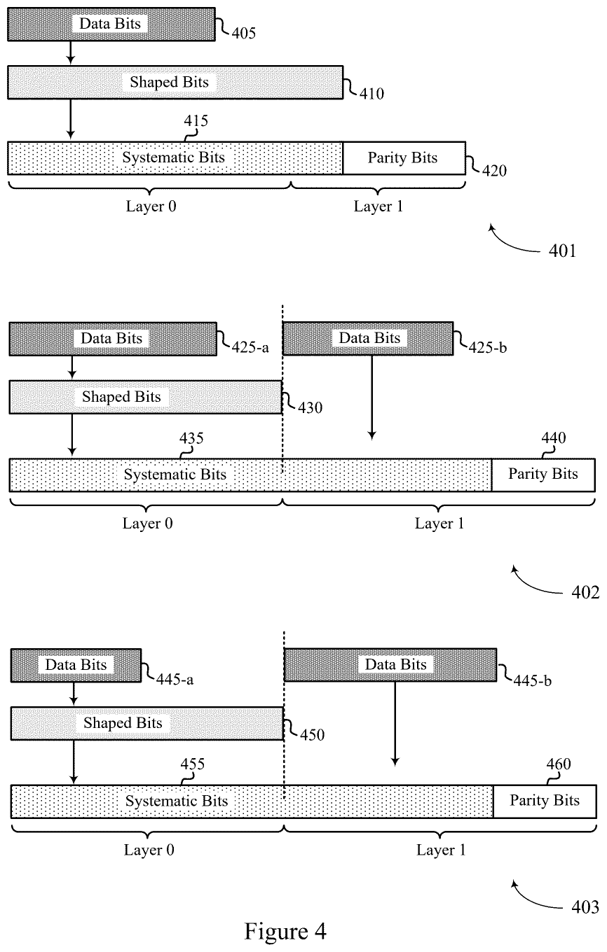

FIG. 4 shows an example of a code block shaping scheme 401, a code block shaping scheme 402, and a code block shaping scheme 402 that supports partial code block shaping for multi-layer transmissions. In some examples, the shaping schemes described with reference to FIG. 4 may be performed by a network node (e.g., the network node 105 as described with reference to FIGS. 1, 2, and 3) or a UE (such as a UE 115 as described with reference to FIGS. 1, 2, and 3).

To support partial code block shaping for multi-layer transmissions, the transmitting device (such as the UE 115 and/or the network node 105) may derive transmission parameters and/or coding parameters for the partial shaping using parameters used for a full code block shaping scheme. In such cases, a device may store a single modulation coding scheme (MCS) table for probabilistic amplitude shaping, rather than storing multiple MCS tables for all possible combinations of the partial code block shaping (for multiple different QAM types).

For code block shaping scheme 401, a transmitting device (such as a UE 115 or a network node 105) may encode two layers (e.g., layer 0, layer 1) for transmission via a multi-layer transmission. The transmitting device may shape a set of data bits 405 (e.g., 9600 coded bits) using a shaping scheme (e.g., a probabilistic shaping scheme) to obtain a set of shaped bits 410. The set of shaped bits 410 may undergo FEC encoding to generate a set of systematic bits 415 and parity bits 420 to generate a total quantity of payload bits (e.g., 6369 bits) which may be modulated using a QAM modulation scheme (e.g., 256 QAM). In an example of full code block probabilistic code block shaping, the transmitting device may perform FEC encoding using a first encoding rate (e.g., 0.8572) and may use a first Maxwell-Boltzmann shaping parameter (e.g., ν_{MB}=0.0238). In some aspects, the code block shaping scheme 401 may support partial code block shaping using the same FEC rate and Maxwell-Boltzmann shaping parameter of a full code block shaping scheme, and the partial shaping may increase spectral efficiency of the multi-layer transmission without derivation of new FEC and shaping parameters. In some examples, a partial shaping scheme (such as code block shaping scheme 402 and code block shaping scheme 403) may use FEC and shaping parameters that are derived based on the FEC and Maxwell-Boltzmann parameters used for the full code block shaping. In some examples, the transmitting device may transmit at least a first portion of the set of systematic bits 415 on a first transmission layer (e.g., Layer 0) of the multi-layer transmission, and may transmit at least a second portion of the set of systematic bits 415 and the parity bits 420 on a second transmission layer (e.g., Layer 1) of the multi-layer transmission.

For code block shaping scheme 402, a transmitting device (such as a UE 115 or a network node 105) may encode two layers (e.g., layer 0, layer 1) for transmission via a multi-layer transmission. The transmitting device may perform a partial code block shaping scheme by shaping a first set of data bits 425-a (e.g., 3854 payload bits) using a shaping scheme (e.g., a probabilistic shaping scheme) to obtain a set of shaped bits 430 (e.g., 4800 shaped bits). The transmitting device may leave a second set of data bits 425-b unshaped (e.g., 2515 unshaped bits). The set of shaped bits 430 and the second set of data bits 425-b may undergo FEC encoding to generate a set of systematic bits 435 and parity bits 440 to generate a total quantity of payload bits which may be modulated using a QAM modulation scheme (e.g., 256 QAM). In an example of the partial code block probabilistic code block shaping, the transmitting device may perform FEC encoding using a first Maxwell-Boltzmann shaping parameter that is the same as the Maxwell-Boltzmann parameter used for a full code block shaping scheme (e.g., ν_{MB}=0.0238), and an FEC encoding rate that is decreased relative to the FEC encoding rate of the full code block shaping scheme (e.g., 0.7620), which may keep the quantity of data bits the same for the full code block shaping and the partial code block shaping. In some aspects, reducing the FEC encoding rate may increase performance for medium to high antenna correlation (e.g., antenna correlation that exceeds a threshold correlation) and high MCS (e.g., MCS that exceeds a threshold MCS) at the transmitting device. For the partial shaping scheme illustrated in the code block shaping scheme 402, the transmitting device may shape a single layer of the multi-layer transmission (e.g., layer 0, layer 1) while leaving the other one or more layers unshaped. In some examples, the transmitting device may transmit at least a first portion of the set of systematic bits 435 corresponding to the set of shaped bits 430 on a first transmission layer (e.g., Layer 0) of the multi-layer transmission, and may transmit at least a second portion of the set of systematic bits 435 (corresponding to the second set of data bits 425-b) and the parity bits 440 on a second transmission layer (e.g., Layer 1) of the multi-layer transmission.

For code block shaping scheme 403, a transmitting device (such as a UE 115 or a network node 105) may encode two layers (e.g., layer 0, layer 1) for transmission via a multi-layer transmission. The transmitting device may perform a partial code block shaping scheme by shaping a first set of data bits 445-a (e.g., 2916 payload bits) using a shaping scheme (e.g., a probabilistic shaping scheme) to obtain a set of shaped bits 450 (e.g., 4800 shaped bits). The transmitting device may leave a second set of data bits 445-b unshaped (e.g., 3453 unshaped bits). The set of shaped bits 450 and the second set of data bits 445-b may undergo FEC encoding to generate a set of systematic bits 455 and parity bits 460 to generate a total quantity of payload bits which may be modulated using a QAM modulation scheme (e.g., 256 QAM). In an example of the partial code block probabilistic code block shaping, the transmitting device may perform FEC encoding using a first Maxwell-Boltzmann shaping parameter (e.g., ν_{MB}=0.0718), that is increased relative to the Maxwell-Boltzmann shaping parameter used for a full code block shaping scheme (e.g., ν_{MB}=0.0238), and an FEC encoding rate that is the same as the FEC encoding rate of the full code block shaping scheme (e.g., 0.8572), which may keep the quantity of data bits the same for the full code block shaping and the partial code block shaping. In some aspects, increasing the Maxwell-Boltzmann shaping parameter may increase shaping gain for the multi-layer transmission. For the partial shaping scheme illustrated in the code block shaping scheme 403, the transmitting device may shape a single layer of the multi-layer transmission (e.g., layer 0, layer 1) while leaving the other one or more layers unshaped. In some examples, the transmitting device may transmit at least a first portion of the set of systematic bits 455 corresponding to the set of shaped bits 450 on a first transmission layer (e.g., Layer 0) of the multi-layer transmission, and may transmit at least a second portion of the set of systematic bits 455 (corresponding to the second set of data bits 445-b) and the parity bits 460 on a second transmission layer (e.g., Layer 1) of the multi-layer transmission.

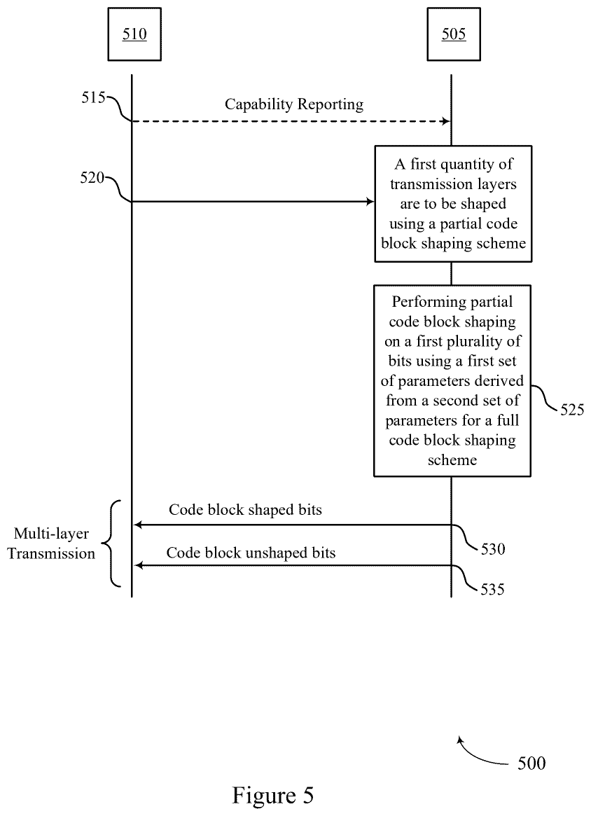

FIG. 5 shows an example of a process flow 500 that supports partial code block shaping for multi-layer transmissions. For example, the process flow 500 may support communications between a first wireless node 505 and a second wireless node 510, each of which may be an example of a UE 115, a network node 105, or a combination thereof, as described herein.

Alternative examples of the following may be implemented. Some steps are performed in a different order than described or are not performed at all. In some implementations, steps may include additional features not mentioned below, or additional steps may be added. Further, although first wireless node 505 and the second wireless node 510 are shown performing the operations of the process flow 500, some aspects of some operations may also be performed by one or more other wireless communication devices (such as by multiple network nodes, multiple UEs).

At 520, the first wireless node 505 may receive one or more messages (e.g., a DCI message, an RRC message, a MAC-CE, or any combination thereof) that indicate a first quantity of transmission layers of a multi-layer transmission that are to be shaped in accordance with a partial code block shaping scheme. In some examples, the quantity of transmission layers may be indicated using one or more field values included in one or more fields of the one or more messages. For example, a first field value may indicate no code block shaping (e.g., the first wireless node 505 may not perform code block shaping for the code block bits), a second field value may indicate full code block shaping (e.g., the first wireless node 505 may perform full code block shaping for the code block bits), and a set of one or more field values (values between the first field value and the second field value) may indicate partial code block shaping. In some cases, the first quantity of transmission layers indicated by the one or more messages include a quantity of shaped transmission layers that correspond to a transmission rank of the multi-layer transmission.

In some examples, the first wireless node 505 may transmit a capability report 515 that indicates a shaping capability of the first wireless node 505 which includes a maximum supported quantity of shaped layers for a bandwidth for transmission of the multi-layer transmission. For example, the maximum supported quantity of shaped layers for a first bandwidth may be different from the maximum supported quantity of shaped layers for a second bandwidth different from the first bandwidth.

At 525, the first wireless node 505 may perform a partial code block shaping (e.g., code block shaping scheme 402, code block shaping scheme 403) on a first set of bits to generate a set of code block shaped bits using a first set of parameters for the partial code block shaping scheme. In some aspects, the first wireless node may derive the first set of parameters for the partial code block shaping scheme from a second set of parameters for a full code block shaping scheme. The first set of parameters and the second set of parameters may include at least a shaping parameter such as a Maxwell-Boltzmann parameter, and a coding rate such as an FEC rate.

In some examples, the first wireless node 505 may derive the first set of parameters for the partial code block shaping scheme from the second set of parameters for the full code block shaping scheme. For example, the first set of parameters may include a first coding rate for the partial code block shaping scheme (that is also applicable for the full code block shaping scheme), a first shaping parameter for the partial code block shaping scheme that is increased relative to a second shaping parameter for the full code block shaping scheme, and a first quantity of the first plurality of bits for the partial code block shaping scheme (that is also applicable for the full code block shaping scheme).

In some examples, the first wireless node 505 may derive the first set of parameters for the partial code block shaping scheme from the second set of parameters for the full code block shaping scheme. For example, the first set of parameters may include a first coding rate for the partial code block shaping scheme that is decreased relative to a second coding rate for the full code block shaping scheme, a first shaping parameter for the partial code block shaping scheme (that is also applicable for the full code block shaping scheme), and a first quantity of the first plurality of bits for the partial code block shaping scheme (that is also applicable for the full code block shaping scheme).

In some examples, the first set of parameters for the partial code block shaping scheme are the same as the second set of parameters for the full code block shaping scheme. For example, the first set of parameters and the second set of parameters may include a first coding rate applicable to the full code block shaping scheme, a first shaping parameter applicable to the full code block shaping scheme, and a first quantity of the first plurality of bits applicable to the full code block shaping scheme.

To perform the partial code block shaping scheme on the first set of bits, the first wireless node 505 may implement the partial code block shaping scheme to generate the set of code block shaped bits, a set of unshaped data bits, and a set of parity bits. The first wireless node may modulate (e.g., using a modulation scheme such as QPSK modulation), the set of code block shaped bits, the set of unshaped data bits, and the set of parity bits. In some examples, the first wireless node 505 may transmit the set of code block shaped bits on one or more first layers of the multi-layer transmission, and may transmit the set of unshaped data bits and the set of parity bits on one or more second layers of the multi-layer transmission. In some examples, the first wireless node 505 may receive a message that indicates an MCS table to apply for the partial code block shaping scheme.

At 530, the first wireless node 505 may transmit to the second wireless node 510, the set of code block shaped bits of the multi-layer transmission on the first quantity of layers. For example, the first wireless node 505 may apply a partial code block shaping scheme for bits transmitting on the first quantity of layers of the multi-layer transmission (e.g., the first quantity of layers are shaped using the code block shaping scheme) At 535, the first wireless node 505 may transmit to the second wireless node 510, the set of unshaped code block bits of the multi-layer transmission on a second quantity of layers. For example, the first wireless node 505 may not apply code block shaping for bits transmitted on the second quantity of layers (e.g., the first wireless node 505 may leave the second quantity of layers unshaped).

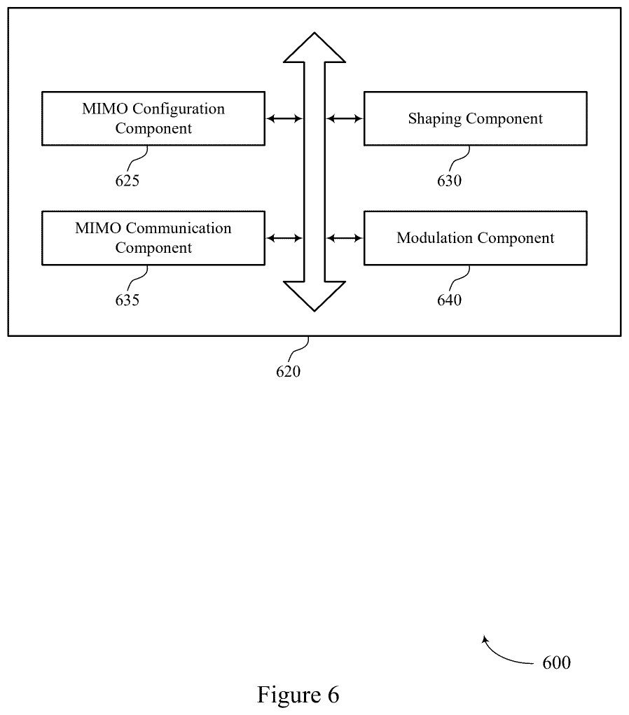

FIG. 6 shows an example 600 of a processing system 620 that supports partial code block shaping for multi-layer transmissions. A processing system 620 may be an example of a processing system 145 (such as network node 105) and may include a MIMO configuration component 625, a shaping component 630, a MIMO communication component 635, a modulation component 640, or any combination thereof. A processing system 620, or various component thereof, may be an example of means for performing (such as a means for causing a network node 105 to perform) various techniques described herein.

The MIMO configuration component 625 may be configured to cause the UE 115 or the network node 105 to communicate one or more messages indicative of a first quantity of transmission layers of a multi-layer transmission that are to be shaped in accordance with a partial code block shaping scheme. The shaping component 630 may be configured to cause the UE 115 or the network node 105 to perform partial code block shaping on a first set of multiple bits to generate a set of multiple code block shaped bits in accordance with a first set of parameters for the partial code block shaping scheme, the first set of parameters for the partial code block shaping scheme being derived from a second set of parameters for a full code block shaping scheme. The MIMO communication component 635 may be configured to cause the UE 115 or the network node 105 to transmit the set of multiple code block shaped bits of the multi-layer transmission on the first quantity of layers. In some examples, the MIMO communication component 635 may be configured to cause the UE 115 or the network node 105 to transmit a set of multiple unshaped code block bits of the multi-layer transmission on a second quantity of layers.

In some examples, to support performing the partial code block shaping scheme on the first set of multiple bits, the shaping component 630 may be configured to cause the UE 115 or the network node 105 to derive the first set of parameters for the partial code block shaping scheme from the second set of parameters for the full code block shaping scheme, the first set of parameters including a first coding rate for the partial code block shaping scheme and the full code block shaping scheme, a first shaping parameter for the partial code block shaping scheme that is increased relative to a second shaping parameter for the full code block shaping scheme, and a first quantity of the first set of multiple bits for the partial code block shaping scheme and the full code block shaping scheme.

In some examples, to support performing the partial code block shaping scheme on the first set of multiple bits, the shaping component 630 may be configured to cause the UE 115 or the network node 105 to derive the first set of parameters for the partial code block shaping scheme from the second set of parameters for the full code block shaping scheme, the first set of parameters including a first coding rate for the partial code block shaping scheme that is decreased relative to a second coding rate for the full code block shaping scheme, a first shaping parameter for the partial code block shaping scheme and the full code block shaping scheme, and a first quantity of the first set of multiple bits for the partial code block shaping scheme and the full code block shaping scheme.

In some examples, the first set of parameters for the partial code block shaping scheme and the second set of parameters for the full code block shaping scheme include a same set of parameters, the first set of parameters including a first coding rate applicable to the full code block shaping scheme, a first shaping parameter applicable to the full code block shaping scheme, and a first quantity of the first set of multiple bits applicable to the full code block shaping scheme.

In some examples, the MIMO configuration component 625 may be configured to cause the UE 115 or the network node 105 to communicate a capability report indicative of a shaping capability, the shaping capability including a maximum supported quantity of shaped layers for a bandwidth for transmission of the multi-layer transmission. In some examples, the maximum supported quantity of shaped layers for a first supported bandwidth is different from the maximum supported quantity of shaped layers for a second supported bandwidth.

In some examples, to support performing the partial code block shaping scheme on the first set of multiple bits, the shaping component 630 may be configured to cause the UE 115 or the network node 105 to generate the set of multiple code block shaped bits, a set of multiple unshaped data bits, and a set of multiple parity bits in accordance with the partial code block shaping scheme. In some examples, to support performing the partial code block shaping scheme on the first set of multiple bits, the modulation component 640 may be configured to cause the UE 115 or the network node 105 to modulating, used a modulation scheme, the set of multiple code block shaped bits, the set of multiple unshaped data bits, and the set of multiple parity bits, where the set of multiple code block shaped bits are transmitted on one or more first layers of the multi-layer transmission, the set of multiple unshaped data bits and the set of multiple parity bits being transmitted on one or more second layers of the multi-layer transmission.

In some examples, the first quantity of transmission layers are indicated using a set of values included in a field of the one or more messages, the set of values including at least a first value indicative of no code block shaping, a second value indicative of the full code block shaping scheme, and one or more values between the first value and the second value indicative of the partial code block shaping scheme. In some examples, the one or more messages include a DCI message, an RRC message, a MAC-CE, or any combination thereof.

In some examples, the first quantity of transmission layers indicated by the one or more messages include a quantity of shaped transmission layers that correspond to a transmission rank of the multi-layer transmission. In some examples, the modulation component 640 may be configured to cause the UE 115 or the network node 105 to communicate a message indicative of an MCS table applicable for the partial code block shaping scheme. In some examples, the first set of parameters and the second set of parameters include at least a shaping parameter and a coding rate, the shaping parameter being a Maxwell-Boltzmann parameter, and the coding rate being an FEC rate.

By including or configuring a processing system 620 for operation in a processing system 620 as described herein, the processing system 620 may support techniques for improved communication reliability, improved user experience related to reduced processing, reduced power consumption, improved coordination between devices, improved utilization of processing capability, increased performance (e.g., increased SINR) due to probabilistic code block shaping, reduced nonlinearity for received symbols of a multi-layer transmission, increased on-device memory allocation.

In some cases, the MIMO configuration component 625, the shaping component 630, the MIMO communication component 635, the modulation component 640, or any combination thereof, may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the MIMO configuration component 625, the shaping component 630, the MIMO communication component 635, the modulation component 640, or any combination thereof, as discussed herein.

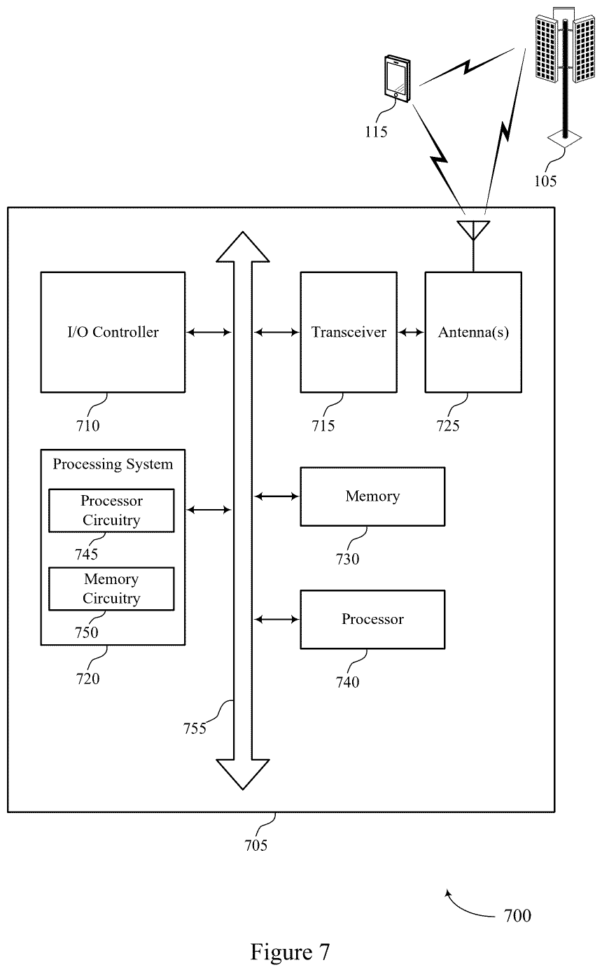

FIG. 7 shows an example of a system 700 including a device 705 that supports partial code block shaping for multi-layer transmissions. The device 705 may be an example of or include components of UE 115. The device 705 may communicate (such as wirelessly) with one or more other devices (such as network nodes 105, UEs 115). The device 705 may include components for transmitting and receiving communication, which may include a processing system 720, an input/output (I/O) controller, such as an I/O controller 710, a transceiver 715, antenna(s) 725, a memory 730, and a processor 740. Components of the device 705 may be coupled (such as operatively, communicatively, functionally, electronically, electrically, in electronic communication) a bus 755.

The transceiver 715 may support bi-directional communication via antenna(s) 725, and may support transmission operations, reception operations, or both, as described herein. The transceiver 715 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 705). The transceiver 715 may modulate symbols and provide the modulated symbols to antenna(s) 725 for transmission, and demodulate symbols from signals received using antenna(s) 725.

The processor 740 may be a general-purpose processing component that supports various operations (such as applications) of the device 705. The memory 730 may be a general-purpose storage component that stores code executable by the processor 740. Such code may include instructions that, when executed by the processor 740, cause the device 705 to perform various functions (such as to support an application of the device 705). The I/O controller 710 may manage inputs and outputs for the device 705, may manage peripherals not integrated into the device 705, or may represent a physical connection (such as port) to an external peripheral. The processor 740 may interact with a modem, a keyboard, a mouse, a touchscreen, or other device (such as via I/O controller 710). In some implementations, a user may interact with the device 705 via the I/O controller 710 or via hardware components controlled by the I/O controller 710.

The processing system 720 may be an example of a processing system 140 or a processing system 620. For example, the processing system 720 may include processor circuitry 745 and memory circuitry 750 that stores code, and may be configured to cause the device 705 to perform operations that support partial code block shaping for multi-layer transmissions. Although the processing system 720 is illustrated as a separate component, which may involve a separate chip, chipset, or other module, in some implementations, one or more functions described with reference to the processing system 720 may be supported by or performed by a transceiver 715, antenna(s) 725, a processor 740, memory 730, or any combination thereof, such that a processing system 720 may include one or more of a transceiver 715, antenna(s) 725, a processor 740, memory 730, or any combination thereof.

By including or configuring the processing system 720 for operation in the device 705 as described herein, may support techniques for improved communication reliability, improved user experience related to reduced processing, reduced power consumption, improved coordination between devices, improved utilization of processing capability, increased performance (e.g., increased SINR) due to probabilistic code block shaping, reduced nonlinearity for received symbols of a multi-layer transmission, increased on-device memory allocation.

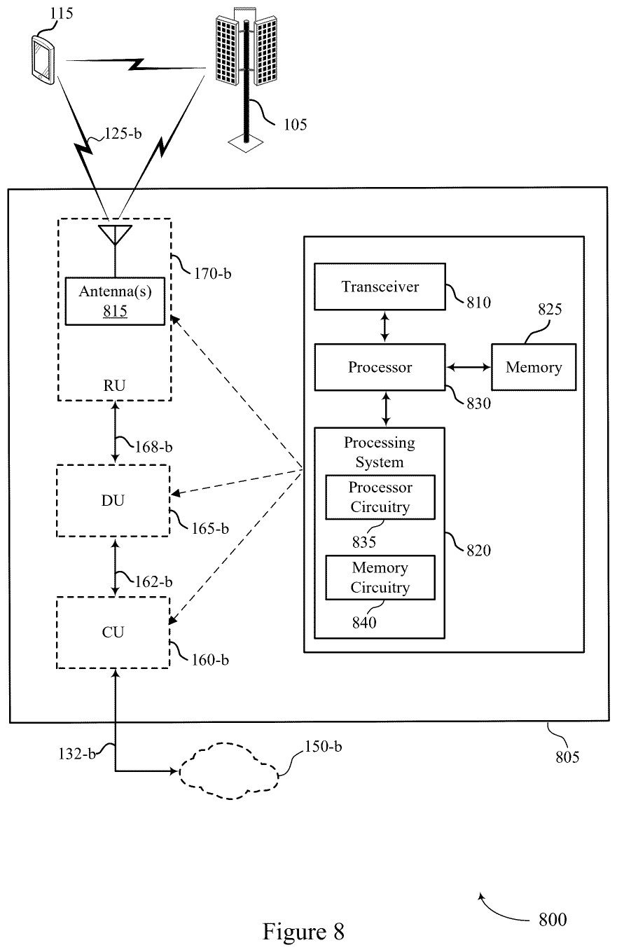

FIG. 8 shows an example of a system 800 including a device 805 that supports partial code block shaping for multi-layer transmissions. The device 805 may communicate (such as via one or more wired interfaces or one or more wireless interfaces) with other network devices or network equipment such as a core network 150-b, other network nodes 105, UEs 115, or any combination thereof. The device 805 may include components for transmitting and receiving communication, which may include a processing system 820, a transceiver 810, antenna(s) 815, a memory 825, and a processor 830. Components of the device 805 may be coupled (such as operatively, communicatively, functionally, electronically, electrically, in electronic communication) via one or more interfaces.

The transceiver 810 may communicate bi-directionally with another transceiver via wired or wireless links, and may support transmission operations, reception operations, or both, as described herein. The transceiver 810 may include a modem to modulate and demodulate signals, to provide the modulated signals for transmission (such as via antenna(s) 815, via a wired interface), and to demodulate received signals (such as received via antenna(s) 815, received via a wired interface). The transceiver 810 may be operable to support communication via one or more communication links (such as a communication link 125-b, a backhaul link 132-b, a midhaul link 162-b, fronthaul link 168-b).

The processor 830 may be a general-purpose processing component that supports various operations (such as applications) of the device 805. The memory 825 may be a general-purpose storage component that stores code executable by the processor 830. Such code may include instructions that, when executed by the processor 830, cause the device 805 to perform various functions (such as to support an application of the device 805).

For examples in which the device 805 is a network node 105 in a disaggregated architecture, one or more components of the device 805 may be located at one or more of a CU 160-b, a DU 165-b, or an RU 170-b, one or more of which may include aspects of the processing system 820, the processor 830, the memory 825, or the transceiver 810. Functions of the device 805 may be performed at different components or an operation may be divided between different components (such as different functions being supported by aspects of the CU 160-b, the DU 165-b, or the RU 170-b, the transceiver 810, the processor 830, the memory 825, the processing system 820, or any combination thereof). For example, the processing system 820 may be a component of one or more of the CU 160-b, the DU 165-b, or the RU 170-b. In some examples, interfaces between components of device 805 (such as CU 160-b, DU 165-b, RU 170-b) may support communication at a protocol layer or between protocol layers of a protocol stack.

In some examples, the processing system 820 may manage aspects of communication with the core network 150-b (such as via a backhaul link 132). For example, the processing system 820 may manage the transfer of data communication for UEs 115 with a gateway of the core network 150-b. In some examples, the processing system 820 may manage communication with one or more other network nodes 105 and may include a controller or scheduler for controlling communication with UEs 115 (such as in cooperation with the one or more other network nodes 105). In some examples, the processing system 820 may support an interface (such as X2 interface, Xn interface) to provide communication between network nodes 105.

The processing system 820 may be an example of a processing system 145 or a processing system 620. For example, the processing system 820 may include processor circuitry 835 and memory circuitry 840 that stores code, and the processing system 820 may be configured to cause the device 805 to perform operations that support partial code block shaping for multi-layer transmissions. Although the processing system 820 is illustrated as a separate component, which may involve a separate chip, chipset, or other module, in some implementations, one or more functions described with reference to the processing system 820 may be supported by or performed by a transceiver 810, antenna(s) 815, a processor 830, memory 825, or any combination thereof, such that a processing system 820 may include one or more of a transceiver 810, antenna(s) 815, a processor 830, memory 825, or any combination thereof. Further, processor circuitry 835 and memory circuitry 840 each may be implemented at the device 805 in accordance with an aggregated architecture, or the processor circuitry 835 and the memory circuitry 840 may be implemented at one or more of a CU 160-b, a DU 165-b, or an RU 170-b in accordance with a disaggregated architecture.

By including or configuring the processing system 820 for operation in the device 805 as described herein, may support techniques for improved communication reliability, improved user experience related to reduced processing, reduced power consumption, improved coordination between devices, improved utilization of processing capability, increased performance (e.g., increased SINR) due to probabilistic code block shaping, reduced nonlinearity for received symbols of a multi-layer transmission, increased on-device memory allocation.

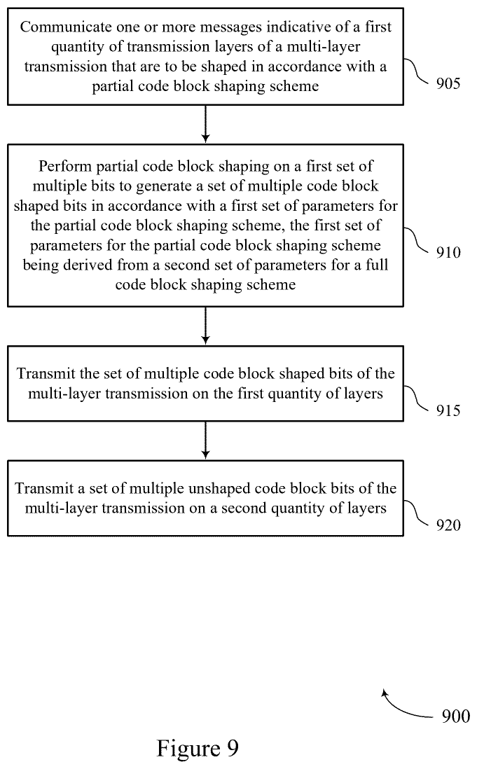

FIG. 9 shows an example of a method 900 that supports partial code block shaping for multi-layer transmissions. Operations of the method 900 may be performed by a UE 115 or a network node 105 or respective components (such as using a processing system configured to cause the respective device to perform one or more of the operations), as described herein.

At 905, the method may include communicating one or more messages indicative of a first quantity of transmission layers of a multi-layer transmission that are to be shaped in accordance with a partial code block shaping scheme. In some examples, aspects of the operations of 905 may be performed by a MIMO configuration component 625.

At 910, the method may include performing partial code block shaping on a first set of multiple bits to generate a set of multiple code block shaped bits in accordance with a first set of parameters for the partial code block shaping scheme, the first set of parameters for the partial code block shaping scheme being derived from a second set of parameters for a full code block shaping scheme. In some examples, aspects of the operations of 910 may be performed by a shaping component 630.

At 915, the method may include transmitting the set of multiple code block shaped bits of the multi-layer transmission on the first quantity of layers. In some examples, aspects of the operations of 915 may be performed by a MIMO communication component 635.

At 920, the method may include transmitting a set of multiple unshaped code block bits of the multi-layer transmission on a second quantity of layers. In some examples, aspects of the operations of 920 may be performed by a MIMO communication component 635.

Implementation examples are described in the following numbered clauses:

Aspect 1: A method for wireless communications, comprising: communicating one or more messages indicative of a first quantity of transmission layers of a multi-layer transmission that are to be shaped in accordance with a partial code block shaping scheme; performing partial code block shaping on a first plurality of bits to generate a plurality of code block shaped bits in accordance with a first set of parameters for the partial code block shaping scheme, the first set of parameters for the partial code block shaping scheme being derived from a second set of parameters for a full code block shaping scheme; transmitting the plurality of code block shaped bits of the multi-layer transmission on the first quantity of layers; and transmitting a plurality of unshaped code block bits of the multi-layer transmission on a second quantity of layers.

Aspect 2: The method of aspect 1, wherein performing the partial code block shaping scheme on the first plurality of bits comprises: deriving the first set of parameters for the partial code block shaping scheme from the second set of parameters for the full code block shaping scheme, the first set of parameters comprising a first coding rate for the partial code block shaping scheme and the full code block shaping scheme, a first shaping parameter for the partial code block shaping scheme that is increased relative to a second shaping parameter for the full code block shaping scheme, and a first quantity of the first plurality of bits for the partial code block shaping scheme and the full code block shaping scheme.

Aspect 3: The method of any of aspects 1 through 2, wherein performing the partial code block shaping scheme on the first plurality of bits comprises: deriving the first set of parameters for the partial code block shaping scheme from the second set of parameters for the full code block shaping scheme, the first set of parameters comprising a first coding rate for the partial code block shaping scheme that is decreased relative to a second coding rate for the full code block shaping scheme, a first shaping parameter for the partial code block shaping scheme and the full code block shaping scheme, and a first quantity of the first plurality of bits for the partial code block shaping scheme and the full code block shaping scheme.

Aspect 4: The method of any of aspects 1 through 3, wherein the first set of parameters for the partial code block shaping scheme and the second set of parameters for the full code block shaping scheme comprise a same set of parameters, the first set of parameters comprising a first coding rate applicable to the full code block shaping scheme, a first shaping parameter applicable to the full code block shaping scheme, and a first quantity of the first plurality of bits applicable to the full code block shaping scheme.

Aspect 5: The method of any of aspects 1 through 4, further comprising: communicating a capability report indicative of a shaping capability, the shaping capability including a maximum supported quantity of shaped layers for a bandwidth for transmission of the multi-layer transmission.

Aspect 6: The method of aspect 5, wherein the maximum supported quantity of shaped layers for a first supported bandwidth is different from the maximum supported quantity of shaped layers for a second supported bandwidth.

Aspect 7: The method of any of aspects 1 through 6, wherein performing the partial code block shaping scheme on the first plurality of bits comprises: generating the plurality of code block shaped bits, a plurality of unshaped data bits, and a plurality of parity bits in accordance with the partial code block shaping scheme; and modulating, using a modulation scheme, the plurality of code block shaped bits, the plurality of unshaped data bits, and the plurality of parity bits, wherein the plurality of code block shaped bits are transmitted on one or more first layers of the multi-layer transmission, the plurality of unshaped data bits and the plurality of parity bits being transmitted on one or more second layers of the multi-layer transmission.

Aspect 8: The method of any of aspects 1 through 7, wherein the first quantity of transmission layers are indicated using a set of values included in a field of the one or more messages, the set of values comprising at least a first value indicative of no code block shaping, a second value indicative of the full code block shaping scheme, and one or more values between the first value and the second value indicative of the partial code block shaping scheme.

Aspect 9: The method of any of aspects 1 through 8, wherein the one or more messages comprise a DCI message, an RRC message, a MAC-CE, or any combination thereof.

Aspect 10: The method of any of aspects 1 through 9, wherein the first quantity of transmission layers indicated by the one or more messages comprise a quantity of shaped transmission layers that correspond to a transmission rank of the multi-layer transmission.

Aspect 11: The method of any of aspects 1 through 10, further comprising: communicating a message indicative of an MCS table applicable for the partial code block shaping scheme.

Aspect 12: The method of any of aspects 1 through 11, wherein the first set of parameters and the second set of parameters include at least a shaping parameter and a coding rate, the shaping parameter being a Maxwell-Boltzmann parameter, and the coding rate being an FEC rate.

Aspect 13: An apparatus for wireless communications, comprising a processing system that includes processor circuitry and memory circuitry that stores code, the processing system configured to cause the apparatus to perform a method of any of aspects 1 through 12.

Aspect 14: An apparatus for wireless communications, comprising at least one means for performing a method of any of aspects 1 through 12.

Aspect 15: A non-transitory computer-readable medium storing code for wireless communications, the code comprising instructions executable by one or more processors to perform a method of any of aspects 1 through 12.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
a processing system that includes processor circuitry and memory circuitry that stores code, the processing system configured to cause the apparatus to:
communicate one or more messages indicative of a first quantity of transmission layers of a multi-layer transmission that are to be shaped in accordance with a partial code block shaping scheme;
perform partial code block shaping on a first plurality of bits to generate a plurality of code block shaped bits in accordance with a first set of parameters for the partial code block shaping scheme, the first set of parameters for the partial code block shaping scheme being derived from a second set of parameters for a full code block shaping scheme;
transmit the plurality of code block shaped bits of the multi-layer transmission on the first quantity of layers; and
transmit a plurality of unshaped code block bits of the multi-layer transmission on a second quantity of layers.

2. The apparatus of claim 1, wherein, to perform the partial code block shaping scheme on the first plurality of bits, the processing system is configured to cause the apparatus to:
derive the first set of parameters for the partial code block shaping scheme from the second set of parameters for the full code block shaping scheme, the first set of parameters comprising a first coding rate for the partial code block shaping scheme and the full code block shaping scheme, a first shaping parameter for the partial code block shaping scheme that is increased relative to a second shaping parameter for the full code block shaping scheme, and a first quantity of the first plurality of bits for the partial code block shaping scheme and the full code block shaping scheme.

3. The apparatus of claim 1, wherein, to perform the partial code block shaping scheme on the first plurality of bits, the processing system is configured to cause the apparatus to:
derive the first set of parameters for the partial code block shaping scheme from the second set of parameters for the full code block shaping scheme, the first set of parameters comprising a first coding rate for the partial code block shaping scheme that is decreased relative to a second coding rate for the full code block shaping scheme, a first shaping parameter for the partial code block shaping scheme and the full code block shaping scheme, and a first quantity of the first plurality of bits for the partial code block shaping scheme and the full code block shaping scheme.

4. The apparatus of claim 1, wherein the first set of parameters for the partial code block shaping scheme and the second set of parameters for the full code block shaping scheme comprise a same set of parameters, the first set of parameters comprising:
a first coding rate applicable to the full code block shaping scheme, a first shaping parameter applicable to the full code block shaping scheme, and a first quantity of the first plurality of bits applicable to the full code block shaping scheme.

5. The apparatus of claim 1, wherein the processing system is further configured to cause the apparatus to:
communicate a capability report indicative of a shaping capability, the shaping capability including a maximum supported quantity of shaped layers for a bandwidth for transmission of the multi-layer transmission.

6. The apparatus of claim 5, wherein the maximum supported quantity of shaped layers for a first supported bandwidth is different from the maximum supported quantity of shaped layers for a second supported bandwidth.

7. The apparatus of claim 1, wherein, to perform the partial code block shaping scheme on the first plurality of bits, the processing system is configured to cause the apparatus to:
generate the plurality of code block shaped bits, a plurality of unshaped data bits, and a plurality of parity bits in accordance with the partial code block shaping scheme; and
modulate, used a modulation scheme, the plurality of code block shaped bits, the plurality of unshaped data bits, and the plurality of parity bits, wherein the plurality of code block shaped bits are transmitted on one or more first layers of the multi-layer transmission, the plurality of unshaped data bits and the plurality of parity bits being transmitted on one or more second layers of the multi-layer transmission.

8. The apparatus of claim 1, wherein the first quantity of transmission layers are indicated using a set of values included in a field of the one or more messages, the set of values comprising at least:
a first value indicative of no code block shaping,
a second value indicative of the full code block shaping scheme, and
one or more values between the first value and the second value indicative of the partial code block shaping scheme.

9. The apparatus of claim 1, wherein the one or more messages comprise a downlink control information (DCI) message, a radio resource control (RRC) message, a medium access control-control element (MAC-CE), or any combination thereof.

10. The apparatus of claim 1, wherein the first quantity of transmission layers indicated by the one or more messages comprise a quantity of shaped transmission layers that correspond to a transmission rank of the multi-layer transmission.

11. The apparatus of claim 1, wherein the processing system is further configured to cause the apparatus to:
communicate a message indicative of a modulation and coding scheme (MCS) table applicable for the partial code block shaping scheme.

12. The apparatus of claim 1, wherein the first set of parameters and the second set of parameters include at least a shaping parameter and a coding rate, the shaping parameter being a Maxwell-Boltzmann parameter, and the coding rate being a forward error correction (FEC) rate.

13. A method for wireless communications, comprising:
communicating one or more messages indicative of a first quantity of transmission layers of a multi-layer transmission that are to be shaped in accordance with a partial code block shaping scheme;
performing partial code block shaping on a first plurality of bits to generate a plurality of code block shaped bits in accordance with a first set of parameters for the partial code block shaping scheme, the first set of parameters for the partial code block shaping scheme being derived from a second set of parameters for a full code block shaping scheme;
transmitting the plurality of code block shaped bits of the multi-layer transmission on the first quantity of layers; and
transmitting a plurality of unshaped code block bits of the multi-layer transmission on a second quantity of layers.

14. The method of claim 13, wherein performing the partial code block shaping scheme on the first plurality of bits comprises:
deriving the first set of parameters for the partial code block shaping scheme from the second set of parameters for the full code block shaping scheme, the first set of parameters comprising a first coding rate for the partial code block shaping scheme and the full code block shaping scheme, a first shaping parameter for the partial code block shaping scheme that is increased relative to a second shaping parameter for the full code block shaping scheme, and a first quantity of the first plurality of bits for the partial code block shaping scheme and the full code block shaping scheme.

15. The method of claim 13, wherein performing the partial code block shaping scheme on the first plurality of bits comprises:
deriving the first set of parameters for the partial code block shaping scheme from the second set of parameters for the full code block shaping scheme, the first set of parameters comprising a first coding rate for the partial code block shaping scheme that is decreased relative to a second coding rate for the full code block shaping scheme, a first shaping parameter for the partial code block shaping scheme and the full code block shaping scheme, and a first quantity of the first plurality of bits for the partial code block shaping scheme and the full code block shaping scheme.

16. The method of claim 13, wherein the first set of parameters for the partial code block shaping scheme and the second set of parameters for the full code block shaping scheme comprise a same set of parameters, the first set of parameters comprising:
a first coding rate applicable to the full code block shaping scheme, a first shaping parameter applicable to the full code block shaping scheme, and a first quantity of the first plurality of bits applicable to the full code block shaping scheme.

17. The method of claim 13, further comprising:
communicating a capability report indicative of a shaping capability, the shaping capability including a maximum supported quantity of shaped layers for a bandwidth for transmission of the multi-layer transmission.

18. The method of claim 13, wherein performing the partial code block shaping scheme on the first plurality of bits comprises:
generating the plurality of code block shaped bits, a plurality of unshaped data bits, and a plurality of parity bits in accordance with the partial code block shaping scheme; and
modulating, using a modulation scheme, the plurality of code block shaped bits, the plurality of unshaped data bits, and the plurality of parity bits, wherein the plurality of code block shaped bits are transmitted on one or more first layers of the multi-layer transmission, the plurality of unshaped data bits and the plurality of parity bits being transmitted on one or more second layers of the multi-layer transmission.

19. The method of claim 13, wherein the first quantity of transmission layers are indicated using a set of values included in a field of the one or more messages, the set of values comprising at least:
a first value indicative of no code block shaping,
a second value indicative of the full code block shaping scheme, and
one or more values between the first value and the second value indicative of the partial code block shaping scheme.

20. An apparatus for wireless communications, comprising:
means for communicating one or more messages indicative of a first quantity of transmission layers of a multi-layer transmission that are to be shaped in accordance with a partial code block shaping scheme;
means for performing partial code block shaping on a first plurality of bits to generate a plurality of code block shaped bits in accordance with a first set of parameters for the partial code block shaping scheme, the first set of parameters for the partial code block shaping scheme being derived from a second set of parameters for a full code block shaping scheme;
means for transmitting the plurality of code block shaped bits of the multi-layer transmission on the first quantity of layers; and
means for transmitting a plurality of unshaped code block bits of the multi-layer transmission on a second quantity of layers.
